(19) United States
(12) Patent Application Publication
(10) Pub. No.: US 2024/0354716 A1
(43) Pub. Date: Oct. 24, 2024

(54) SYSTEM FOR DETERMINING MAINTENANCE AND REPAIR OPERATIONS

(71) Applicant: KoiReader Technologies, Inc., Dallas, TX (US)

(72) Inventors: Ashutosh Prasad, Dallas, TX (US); Vivek Prasad, Bengaluru (IN)

(21) Appl. No.: 18/685,769

(22) PCT Filed: Aug. 24, 2022
(86) PCT No.: PCT/US2022/075379

§ 371 Date: Feb. 22, 2024

Related U.S. Application Data
(60) Provisional application No. 63/236,302, filed on Aug. 24, 2021.

(51) Int. Cl. G06Q 10/20; G06Q 30/0283

(52) U.S. Cl. CPC G06Q 10/20; G06Q 30/0283

(57) ABSTRACT

Discussed herein is a system for performing maintenance and repair operations and inspections on vehicles arriving or departing a facility. In some cases, the system may be configured to process sensor data captured by a plurality of sensors associated with the facility to determine if maintenance and repair operations are necessary and/or if the vehicle incurred any damage during transport.

### CROSS-REFERENCE TO RELATED APPLICATIONS

This application is a U.S. national stage application under 35 USC § 371 of International Application No. PCT/US22/75379 filed on Aug. 24, 2022 and entitled “SYSTEM FOR DETERMINING MAINTENANCE AND REPAIR OPERATIONS”, which claims priority to U.S. Provisional Application No. 63/236,302 filed on Aug. 24, 2021 and entitled “System for Determining Maintenance and repair operations,” the entire contents of which are incorporated herein by reference.

### BACKGROUND

Transport vehicles and systems often suffer damage during transit and require maintenance and repairs after one or more trip(s). However, conventional transport inspections are time consuming as they are traditionally performed manually. This results in many transports going large periods of time between inspections in which damage may become worse or result in a costly breakdown.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is an example block diagram of a maintenance and repair operations system for determining a status, assessing damage, and initiating repairs of transport vehicles.

FIG. 2 is a flow diagram illustrating an example process associated with assessing transport vehicles for maintenance and repair operations according to some implementations.

FIG. 3 is a flow diagram illustrating an example process associated with assessing transport vehicles for maintenance and repair operations according to some implementations.

FIG. 4 is a flow diagram illustrating an example process associated with assessing transport vehicles for maintenance and repair operations according to some implementations.

FIG. 5 is an example sensor system that may implement the techniques described herein according to some implementations.

FIG. 6 is an example asset management system that may implement the techniques described herein according to some implementations.

### DETAILED DESCRIPTION

Discussed herein is a system for performing maintenance and repair operations (MRO) and inspections. In some cases, the system may be configured to process sensor data captured by a plurality of sensors associated with a facility. In some cases, the sensors may be positioned either at fixed locations at an arrival or intake area (such as along a runway or along a gate or dock door) of the facility or via mobile autonomous systems, such as autonomous aerial vehicles (AAVs) and/or autonomous submersible vehicles (ASVs). For example, as a cargo plane lands and/or is in transit along a runway after landing, one or more AAV(s) may traverse around the plane to capture sensor data suitable to determine if MRO are necessary and/or if the plane incurred any damage during transport. As another example, as a transport vessel or ship comes into dock, one or more ASV(s) may traverse around the vessel to capture sensor data suitable to determine if MRO are necessary and/or if the vessel incurred any damage during transport, particularly in the portion of the vessel that is submerged underwater (such as CO2 or rust damage) and otherwise not easily inspected. In both cases, the MRO system may utilize the sensor data to determine a status of the transport vehicle (such as available or unavailable, repairs advised, repairs needed, ready, and the like). In other cases, the sensors may be associated with or worn by operators or individuals of the facility, affixed to facility, associated with facility equipment (such as mounted on forklifts, carts, and the like). In the cases of the AAVs and/or operator mounted, the system may be able to capture data associated with an interior as well as an exterior of the vehicle or transport (e.g., the plane or ship). In some instances, the vehicle or transport may also include trucks, carts, trailers, trains, cargo containers, transport handling units (THU), and the like. In some cases, the THU may include, but are not limited to, pallets, cartoons, units, bins, unit load devices (ULDs), ocean containers, any object that may carry or otherwise transport an inventory item, and the like.

In some implementations, the AAVs and/or ASVs may work in conjunction with fixed sensor systems, such as sensors mounted on towers, gates, tunnels, and the like in proximity to the runway. In this manner, the fixed sensors may capture general sensor data associated with the incoming plane and the AAVs and/or ASVs may perform more detailed inspections. In one specific example, the system may process the sensor data from the fixed sensor systems to determine if a more detailed inspection is required. If so, the system may then send instructions to the AAVs and/or ASVs to perform precise or localized data capture on areas in which the plane or other vehicle may have experienced damage or is in need of repair.

In some examples, the sensor system may include one or more internet of things (IoT) device(s). The IoT computing devices may include a smart network video recorder (NVR) or other type of EDGE computing device. Each IoT device may also be equipped with sensors and/or image capture devices, such as visible light image systems, infrared image systems, radar based image systems, LIDAR based image systems, SWIR based image systems, Muon based image systems, radio wave based image systems, and/or the like. In some cases, the IoT computing devices may also be equipped with models and instructions to capture, parse, identify, and extract information associated with a lifecycle of an asset, as discussed herein, in lieu of or in addition to the cloud-based services. For example, the IoT computing devices and/or the cloud-based services may be configured to perform segmentation, classification, attribute detection, recognition, data extraction, and the like.

In some implementations, the MRO system may receive first sensor data associated with an incoming transport or vehicle. The MRO system may apply one or more processes, models, and/or techniques to the first sensor data to determine the identity of the transport. In these examples, the MRO system may maintain a maintenance or status record or log (such as including repairs, damage, current state, and the like) associated with each individual transport or vehicle. In this manner, when a transport is identified, the MRO system may either perform additional processes, operations, and/or techniques based on the status log to determine if any additional damage has occurred or any known damage or issues have undergone a change (e.g., further degraded). In other examples, once the identity of the transport is determined, the MRO system may send instructions (to for instance, an AAV or ASV) to perform an individualized inspection based on the status log. In these cases, older vehicles and/or vehicles with known issues may undergo more detailed inspections and analysis when compared to, for instance, new vehicles or recently updated vehicles. In these examples, the detailed inspection may generate second sensor data that may be used to determine if MRO should be ordered. In one specific example, the MRO system may utilize both the first sensor data and the second sensor data to determine if MRO is ordered.

In the examples in which an AAV and/or ASV is utilized to capture the sensor data, the MRO system may define a path or route for the AAV and/or ASV based on data known about the vehicle, such as size, shape, type, status log data, and the like. In other case, the MRO system may route the AAV and/or ASV between multiple vehicles such as based at least in part on relative locations, known vehicle paths, individual status reports, and the like. For instance, the MRO system may prioritize vehicles with known issues or damage, older vehicles, particular types of vehicles, or the like when a facility is particularly busy, or the MRO system performs a triage event.

In some cases, since the sensor and/or image data received may be from different sources or types of sensors at different ranges and generalities, the MRO system may perform a data normalization using techniques such as threshold-based data normalization and machine learning algorithms to identify the driver, vehicle, or container. It should be understood that the MRO system may utilize different weighted averages or thresholds based on the data source (e.g., sensor type, location, distance, and position), the current weather (e.g., sunny, rainy, snowy, or foggy), and time of day when performing data normalization. In some cases, machine learning algorithms may also be applied to remove the distortion from images caused by rain, dust, sand, fog, and the like as well as to brighten the sensor and/or images shot in low-light or dark conditions.

In some examples, the MRO system may process the sensor data using one or more machine learned model(s) to identify the vehicles, assess damage or concerns, determine repair operations, provide inspection instructions, and the like. As described herein, the machine learned models may be generated using various machine learning techniques. For example, the models may be generated using one or more neural network(s). A neural network may be a biologically inspired algorithm or technique which passes input data (e.g., image and sensor data captured by the IoT (Internet of Things) computing devices) through a series of connected layers to produce an output or learned inference. Each layer in a neural network can also comprise another neural network or can comprise any number of layers (whether convolutional or not). As can be understood in the context of this disclosure, a neural network can utilize machine learning, which can refer to a broad class of such techniques in which an output is generated based on learned parameters.

As an illustrative example, one or more neural network(s) may generate any number of learned inferences or heads from the captured sensor and/or image data. In some cases, the neural network may be a trained network architecture that is end-to-end. In one example, the machine learned models may include segmenting and/or classifying extracted deep convolutional features of the sensor and/or image data into semantic data. In some cases, appropriate truth outputs of the model in the form of semantic per-pixel classifications (e.g., vehicle identifier, container identifier, driver identifier, and the like).

Although discussed in the context of neural networks, any type of machine learning can be used consistent with this disclosure. For example, machine learning algorithms can include, but are not limited to, regression algorithms (e.g., ordinary least squares regression (OLSR), linear regression, logistic regression, stepwise regression, multivariate adaptive regression splines (MARS), locally estimated scatterplot smoothing (LOESS)), instance-based algorithms (e.g., ridge regression, least absolute shrinkage and selection operator (LASSO), elastic net, least-angle regression (LARS)), decisions tree algorithms (e.g., classification and regression tree (CART), iterative dichotomiser 3 (ID3), Chi-squared automatic interaction detection (CHAID), decision stump, conditional decision trees), Bayesian algorithms (e.g., naïve Bayes, Gaussian naïve Bayes, multinomial naïve Bayes, average one-dependence estimators (AODE), Bayesian belief network (BNN), Bayesian networks), clustering algorithms (e.g., k-means, k-medians, expectation maximization (EM), hierarchical clustering), association rule learning algorithms (e.g., perceptron, back-propagation, hopfield network, Radial Basis Function Network (RBFN)), deep learning algorithms (e.g., Deep Boltzmann Machine (DBM), Deep Belief Networks (DBN), Convolutional Neural Network (CNN), Stacked Auto-Encoders), Dimensionality Reduction Algorithms (e.g., Principal Component Analysis (PCA), Principal Component Regression (PCR), Partial Least Squares Regression (PLSR), Sammon Mapping, Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA)), Ensemble Algorithms (e.g., Boosting, Bootstrapped Aggregation (Bagging), AdaBoost, Stacked Generalization (blending), Gradient Boosting Machines (GBM), Gradient Boosted Regression Trees (GBRT), Random Forest), SVM (support vector machine), supervised learning, unsupervised learning, semi-supervised learning, etc. Additional examples of architectures include neural networks such as ResNet50, ResNet101, VGG, DenseNet, PointNet, and the like. In some cases, the system may also apply Gaussian blurs, Bayes Functions, color analyzing or processing techniques and/or a combination thereof.

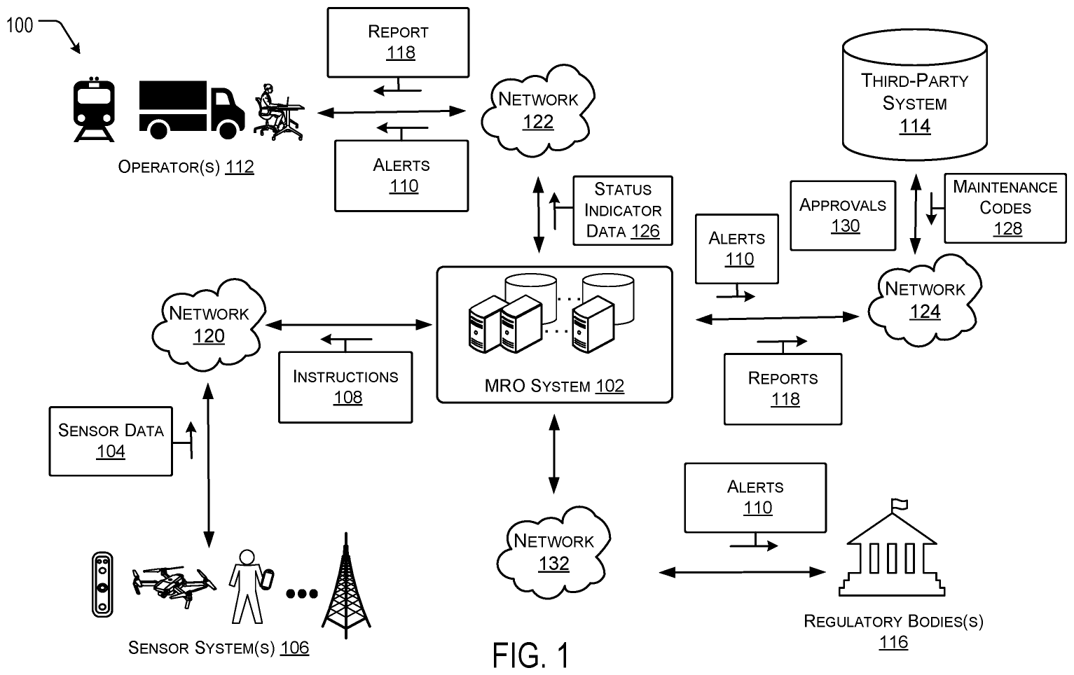

FIG. 1 is an example block diagram 100 of a maintenance and repair operations system 102 for determining a status of the transport, assessing damage, and initiating repairs of transport vehicles. In some cases, the MRO system 102 may be configured to receive sensor data 104 from sensor systems 106 associated with a facility. In some cases, the sensor systems 106 may be fixed at entry locations associated with the facility such as a gate, runway, dock, rail depot and the like. In other cases, the sensor systems may be fixed on towers or associated with AAVs or ASVs, as discussed above. In some cases, the sensor system 106 may be handheld or associated with a downloadable application on a handheld electronic device, such as a smart phone, tablet, or the like. In these cases, a user may scan the transport using the electronic device and the associated downloadable application.

In some cases, the sensor system 106 may include image devices, recording and data storage devices or systems, and the like. During operations, the sensors 106 may collect data along with the image or video, and the like. The image or video data may be sent to a cloud-based service over a wireless interface (such as streaming data) such as the MRO system 102. In some cases, the sensor data 104 may include image data associated with a field of view of the sensor 106 associated with the AAV or ASV.

In some cases, the MRO management system 102 may determine an identity of a transport or vehicle based at least in part on one or more identifier(s) within the sensor data 104, segmented, classified, and/or identified features of the vehicles, or the like. For example, the MRO system 102 may locate and track identifiers (such as license plates) on the vehicle as the vehicle enters the facility. In some cases, the identifiers may be electric, in the form of, for example, an RFID tag, Bluetooth® low energy (BLE) signal, or other wireless communication technology. Upon identification, the MRO management system 102 may access stored status and maintenance log data associated with the identified transport or vehicle.

In some implementations, the MRO management system 102 may, upon an identification, send scanning or data capture instructions 108 to the sensor system 106 based on the identity of the transport vehicle. For instance, the system 102 may determine a type, log, prior scan, make, model, and the like of the transport vehicle based at least in part on initial sensor data and/or the identity. The MRO system 102 may then determine scanning instructions 108, such as flight paths in the case of an AAV, type of sensor data (e.g., thermal, image, and the like), a level of detail to capture various segments or regions of the transport vehicle (such as when prior scans or stored log data of the vehicle indicate trouble spots), and the like. In some cases, the scanning instructions 108 may be based on a current time of day, season, weather condition, temperature, and the like, as scanning may be performed in an exterior environment and the current conditions may affect scanning. For instance, LIDAR data may be more usable in dark or night time conditions than image data.

Additionally, the MRO system 102 may analyze the sensor data 104 to determine a status of the vehicle, such as if the vehicle is damaged, available or ready, unavailable, or otherwise in need of repair operations. As discussed above, the MRO system 102 may utilize one or more machine learned model(s) to segment, classify, and/or otherwise detect damage to or issues with the vehicle based on the sensor data. In one specific example, the MRO system 102 may identify the vehicle and then utilize the sensor data together with log data (such as a status or repair log) to assess or detect new damage to the vehicle. The MRO system 102 may also, based on the detected status and/or the log data, send instructions 108 to one or more sensor system(s) 106, such as an AAV or ASV, to capture additional sensor data associated with the vehicle (such as a specific location or area of the vehicle).

If the vehicle is damaged, the MRO system 102 may generate an alert 110 to notify the operator 112 associated with the vehicle (e.g., a facility operator, vehicle operator, transport agent, maintenance personnel, vehicle owner, or the like) as well a third-party system 114 (e.g., an insurance agent, entity associated with the assets or vehicle, or other like). The MRO system 102 may also inform a regulatory body 116 associated with the vehicle (such as an environmental organization, or the like). In some specific cases, the MRO system 102 may determine theft or unauthorized access to the vehicle based at least in part on the status (such as a broken lock or the like). In these cases, the MRO system 102 may also send an alert 110 to a law enforcement system. The alerts 110 may also be used to notify a third party system 114, the operator 112, or other party of liability or responsibility for any change in status experienced by the transport and/or the assets.

The asset management system 102 may also generate reports 118 associated with the vehicle or transport. The reports 102 may include status (such as damage), suggested repair operations, suggested maintenance operations, a rating (such as red, yellow, green) associated with the readiness of the vehicle, suggested follow up or manual inspections, estimated repair or maintenance costs, or the like. For example, the MRO system 102 may estimate a repair costs in terms of value and time based on the detected damage (e.g., extent, severity, and location), a selected repair or maintenance operation, estimated cost of materials, historical data (such as past repairs). In some cases, the MRO system 102 may utilize maintenance codes 128 received from one or more third party systems 114 in determining the status and/or generating alerts 110 and/or reports 118. In some cases, the MRO system 102 may store data associated with preferred vendors, such as mechanics, electricians, painters, other maintenance entities, and the like, as well as fees associated therewith. Thus, the system 102 may generate the report 118 including the selected or preferred vendor and the estimated costs of using the vendor for the repair operation. In some cases, the report 118 may include a list of vendors and the estimated costs associated with each.

In some cases, the reports 118 may include the current scan, log data, or sensor data 104 that may be used to track changes or damage over time to the transport vehicle. In some cases, the MRO system 102 may store the reports, log data, sensor data 104 as scans that may be used to the MRO system 102 to determine the status indictor data 126, alerts 110, instructions 108, reports 118 as well as incremental damage to the transport vehicle in addition to the maintenance codes 128 received from the third-party system 114. In some cases, the stored scans may be used as a vehicle record over the use of the vehicle and may be used for insurance claims, warranty issues and claims, tracking build quality (such as for use in purchasing new transport vehicles), and the like.

In some implementations, the MRO system 102 may receive an approval 130 from the third-party system 114 to perform operations or order operations (e.g., repair operations, maintenance operations, follow up or manual inspections, and the like), in response to sending the report 118 including suggested repair operations, suggested maintenance operations, suggested follow up or manual inspections, and the like. Upon receiving the approval 130, the MRO system 102 may order the operations at various other third-party systems (such as mechanics or preferred maintenance entities associated with the third party system 114 and the like). In some cases, the MRO system 102 may engage autonomous systems (such as the AAV, ASV, or other automated repair system) to engage or commence in the repair or maintenance operations. For example, the system 102 may issue commands or instructions to a vendor and/or an automated repair system to commence an operation in response to receiving the approval 130. In other cases, the MRO system 102 may be pre-authorized or pre-approved for one or more specific repair or maintenance operations and may issue either instructions to the vendor and/or autonomous repair system prior to or without receiving additional approval from the third-party system 114.

In some cases, the MRO system 102 may also generate, as part of the report 118, a history or log of maintenance operations performed on individual transport vehicles. For example, each time the transport vehicle is sent for repairs, the system 102 may record the repair orders in the reports 118.

The MRO system 102 may also generate status indicator data 126 that may be provided to the vehicle, operator 112, and the like to make the operator 112 aware of the status (such as any issues or concerns). In some case, the status indicator data 126 may cause a green, yellow, or red light to activate to give the operator 112 a quick idea of where the operator 112 should next deliver the transport within, for example, a yard (e.g., to a loading area, staging area, storage area, MRO area, and the like).

In some implementations, the MRO system 102 may also inspect and/or determine MRO operations associated with containers, chassis, and the like in addition to the transport vehicles themselves. For example, the sensor system 106 (such as the AAV, ASV, and/or a facility operator using a camera or sensor) may scan the exterior of a container (such as a rail car container, air freight container, shipping container, and the like). The MRO system 102 may then process the sensor data 104 of the container to determine any issues, damage, and/or a state/status of the container. In some cases, the container may be scanned while being lifted via a crane,, such that all sides may be scanned in a 3D sense. The MRO system 102 may then determine if damage occurred during transit and/or if any repairs are necessary. The MRO system 102 may then issue a repair operation via an alert 110 if so.

The MRO system 102 may also determine liability for the damage such as by using a history or prior status of the container. For instance, the MRO system 102 may compare the damage to historical snapshots or scans of the container to determine liability. In some cases, the MRO system 102 may determine if a container is available or unavailable. If the container is available then the container may be processed as normal by the facility. If the container is unavailable it may be assigned to have MRO performed. In some cases, the MRO system 102 may classify the containers into various stages, such as automatic MRO, MRO advised (e.g., additional inspection), and/or available. Whether a container is marked as available/unavailable and/or the decision can be made to order MRO may be based on a price of the repairs (e.g., below a threshold may be ordered without approval by the MRO system 102), a location of the container (e.g., repair capabilities are at hand, nearby, or unavailable), the company/operator available to perform repairs, a down time analysis, and the like.

In the current example, the sensor data 104, instructions 108, alerts 110 and reports 118 may be sent and/or received by the asset management system 102 via various networks, such as networks 120, 122, 128, and 132.

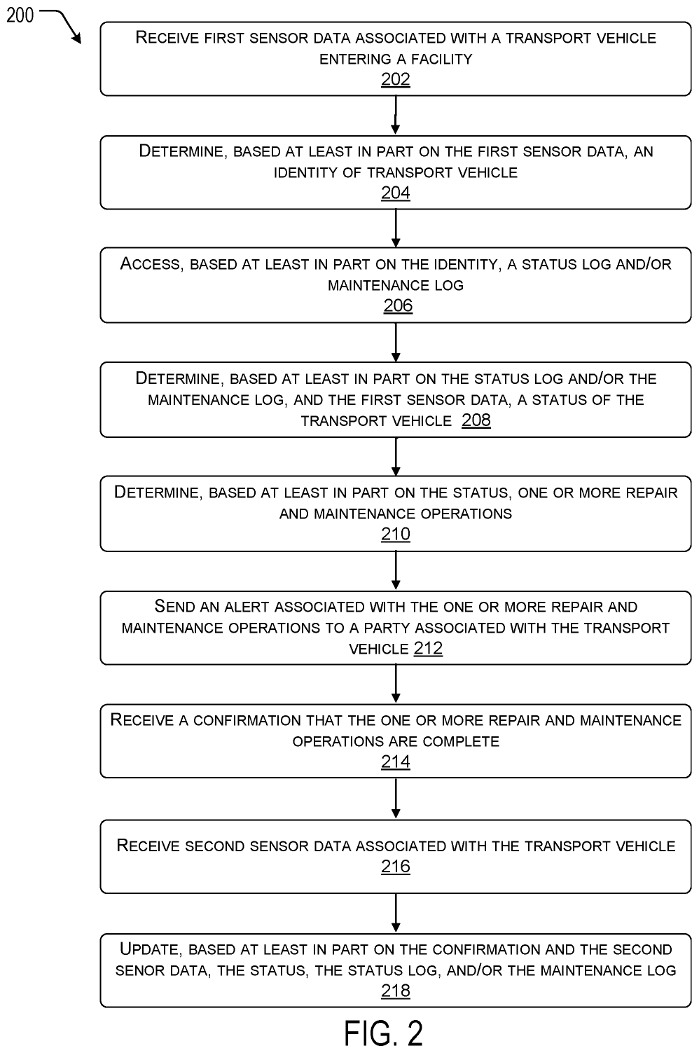

FIGS. 2-4 are flow diagrams illustrating example processes associated with the MRO system discussed herein. The processes are illustrated as a collection of blocks in a logical flow diagram, which represent a sequence of operations, some or all of which can be implemented in hardware, software, or a combination thereof. In the context of software, the blocks represent computer-executable instructions stored on one or more computer-readable media that, when executed by one or more processor(s), performs the recited operations. Generally, computer-executable instructions include routines, programs, objects, components, encryption, deciphering, compressing, recording, data structures and the like that perform particular functions or implement particular abstract data types.

The order in which the operations are described should not be construed as a limitation. Any number of the described blocks can be combined in any order and/or in parallel to implement the processes, or alternative processes, and not all of the blocks need be executed. For discussion purposes, the processes herein are described with reference to the frameworks, architectures and environments described in the examples herein, although the processes may be implemented in a wide variety of other frameworks, architectures or environments.

FIG. 2 is a flow diagram illustrating an example process 200 associated with assessing transport vehicles for maintenance and repair operations according to some implementations. In some case, transport vehicles may require maintenance and repair operations from time to time, such as after completion of a delivery. As discussed above, the MRO system may be configured to receive sensor data associated with the transport vehicle upon arrival at a delivery location or facility and utilize the sensor data as well as log data associated with the transport to determine if any maintenance and repair operations are required or recommended.

At 202, the MRO system may receive first sensor data associated with a transport vehicle entering a facility. For example, the MRO system may be configured to receive sensor data associated with a ship arriving at a dock, a plane taxiing along a runway, a truck or rail car entering a depot or the like. In some cases, the sensor data may be received from one or more fixed sensor(s) mounted around the entry location (e.g., at the gate, along the runway, at the dock, etc.). In other cases, the MRO system may receive the sensor data from one or more AAV(s) operating within the facility and configured to scan or inspect the arriving or parked transport vehicles.

At 204, the MRO system may determine, based at least in part on the first sensor data, an identity of the transport vehicle. For example, the sensor data may be analyzed, segmented, classified and the like to determine the presence of a transport vehicle within the sensor data. In some cases, an identity of the segmented and classified data may then be determined based at least in part on an identifier represented with respect to the sensor data and/or based on the characteristics or features of the segmented and classified objects.

At 206, the MRO system may access, based at least in part on the identity, a status log and/or maintenance log. For example, the MRO system may maintain one or more log(s) associated with each vehicle, such as service operations performed, known damage, maintenance performed, materials used, life stage, age, overall or typical performance, emission ratings, fuel and other fluid consumption, and the like.

At 208, the MRO system may determine, based at least in part on the status log and/or the maintenance log and the first sensor data, a status of the transport vehicle. For example, the MRO system may determine that the transport vehicle is in good working order, that the transport vehicle is due for scheduled repairs or services, that the transport vehicle has new damage or maintenance concerns, a severity of any damage, issue, concern, or the like. In some case, the status may be coded such as red, yellow, green and/or associated with one or more known maintenance codes.

At 210, the MRO system may determine, based at least in part on the status, one or more repair and maintenance operation(s). For example, if the transport vehicle is due for a scheduled operation or if the transport vehicle is showing signs of new damage or an area of concern is progressing, the MRO system may order services or operations via alerts discussed below.

At 212, the MRO system may send an alert associated with the one or more repair and maintenance operation(s) to a party associated with the transport vehicle. For example, the alert may be to order a repair or maintenance operation via a facility staff member or an autonomous repair system. In other cases, the system may also send alerts related to the repairs, status, and/or damage to third parties, such as the owner of the assets being transported, an insurance carrier, a remote manager associated with the vehicle or facility, and the like.

At 214, the MRO system may receive a confirmation that the one or more repair and maintenance operation(s) are complete. For example, the repair and maintenance operations performed may be entered or added to the maintenance logs and/or repair logs. In other cases, the MRO system may receive a confirmation from the autonomous repair system and update the logs directly.

At 216, the MRO system may receive second sensor data associated with the transport vehicle. For instance, the MRO system may cause an AAV or other sensor system to re-inspect the vehicle following the completion of the repair and maintenance operations.

At 218, the MRO system may update, based at least in part on the confirmation and the second sensor data, the status, the status log, and/or the maintenance log. For example, the MRO system may again analyze, segment, classify the second sensor data to determine a new or updated status of the transport vehicle. The MRO system may then use the updated status to update the logs in addition to or in lieu of the log updates performed above with respect to 214.

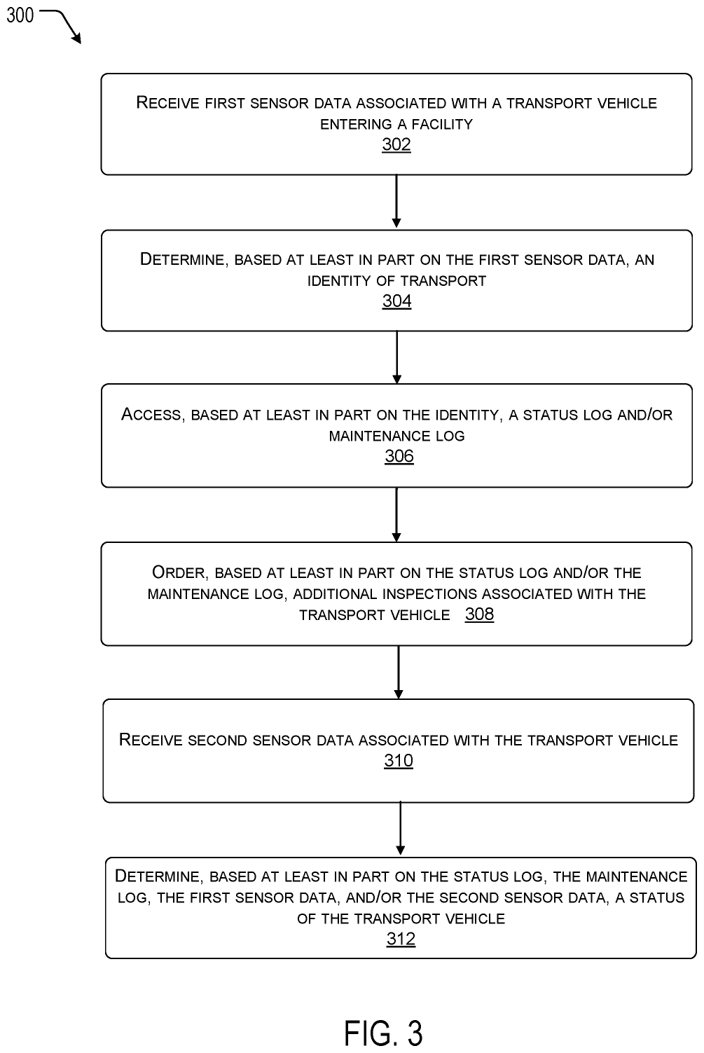

FIG. 3 is a flow diagram illustrating an example process 300 associated with assessing transport vehicles for maintenance and repair operations according to some implementations. In some cases, transport vehicles may require maintenance and repair operations from time to time, such as after completion of a delivery. As discussed above, the MRO system may be configured to receive sensor data associated with the transport vehicle upon arrival at a delivery location or facility and utilize the sensor data as well as log data associated with the transport to determine if any maintenance and repair operations are required or recommended.

At 302, the MRO system may receive first sensor data associated with a transport vehicle entering a facility. For example, the MRO system may be configured to receive first sensor data associated with a ship arriving at a dock, a plane taxiing along a runway, a truck or rail car entering a depot or the like. In some cases, the sensor data may be received from one or more fixed sensor(s) mounted around the entry location (e.g., at the gate, along the runway, at the dock, etc.). In other cases, the MRO system may receive the sensor data from one or more AAV(s) operating within the facility and configured to scan or inspect the arriving or parked transport vehicles.

At 304, the MRO system may determine, based at least in part on the first sensor data, an identity of transport vehicle. For example, the sensor data may be analyzed, segmented, classified and the like to determine the presence of a transport vehicle within the sensor data. In some cases, an identity of the segmented and classified data may then be determined based at least in part on an identifier represented with respect to the sensor data and/or based on the characteristics or features of the segmented and classified objects.

At 306, the MRO system may access, based at least in part on the identity, a status log and/or maintenance log. For example, the MRO system may maintain one or more log(s) associated with each vehicle such as service operations performed, known damage, maintenance performed, materials used, life stage, age, overall or typical performance, emission ratings, fuel and other fluid consumption, and the like.

At 308, the MRO system may order, based at least in part on the status log and/or the maintenance log, additional inspections associated with the transport vehicle. For example, if the transport has known issues or concerns, documented, for example, in the log data, the MRO system may cause an AAV or other sensor system to inspect particular areas of the transport vehicle more closely than with other vehicles.

At 310, the MRO system may receive second sensor data associated with the transport vehicle. For instance, the MRO system may cause an AAV or other sensor system to inspect specific locations of the vehicle as discussed above.

At 312, the MRO system may determine, based at least in part on the status log, the maintenance log, the first sensor data, and/or the second sensor data, a status of the transport vehicle. For example, the MRO system may determine that the transport vehicle is in good working order, that the transport vehicle is due for scheduled repairs or services, that the transport vehicle has new damage or maintenance concerns, a severity of damage or concern, and the like. In some case, the status may be coded such as red, yellow, green. In some cases, the status may include a rating if the transport vehicle is available (e.g., operable) or unavailable (e.g., inoperable) for normal operations.

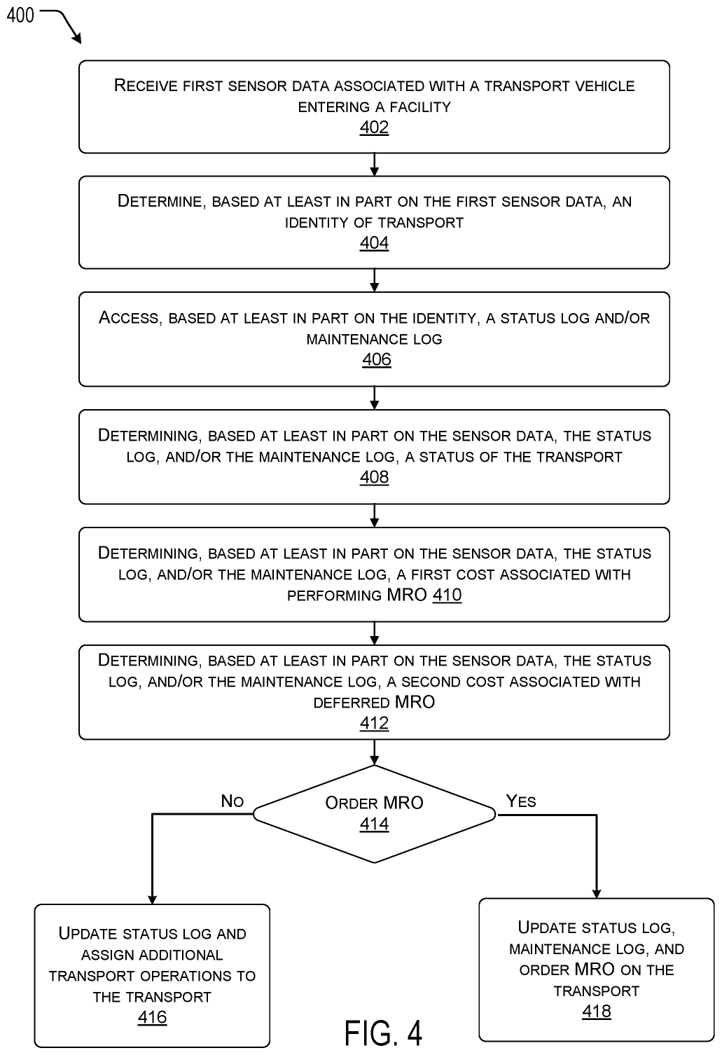

FIG. 4 is a flow diagram illustrating an example process 400 associated with assessing transport vehicles for maintenance and repair operations according to some implementations. In some cases, the MRO system may be configured to determine a cost of the MRO on the transport vehicle and/or assigning liability. In some cases, based on a cost of the MRO and/or an estimated cost of deferring the MRO, the MRO system may either assign additional transport operations and/or MRO to the transport vehicle.

At 402, the MRO system may receive first sensor data associated with a transport vehicle entering a facility. For example, the MRO system may be configured to receive first sensor data associated with a ship arriving at a dock, a plane taxiing along a runway, a truck or rail car entering a depot or the like. In some cases, the sensor data may be received from one or more fixed sensor(s) mounted around the entry location (e.g., at the gate, along the runway, at the dock, etc.). In other cases, the MRO system may receive the sensor data from one or more AAV(s) operating within the facility and configured to scan or inspect the arriving or parked transport vehicles.

At 404, the MRO system may determine, based at least in part on the first sensor data, an identity of the transport vehicle. For example, the sensor data may be analyzed, segmented, classified and the like to determine the presence of a transport vehicle within the sensor data. In some cases, an identity of the segmented and classified data may then be determined based at least in part on an identifier represented with respect to the sensor data and/or based on the characteristics or features of the segmented and classified objects.

At 406, the MRO system may access, based at least in part on the identity, a status log and/or maintenance log. For example, the MRO system may maintain one or more log(s) associated with each vehicle such as service operations performed, known damage, maintenance performed, materials used, life stage, age, overall or typical performance, emission ratings, fuel and other fluid consumption, and the like.

At 408, the MRO system may determine, based at least in part on the sensor data, the status log, and/or the maintenance log, a status of the transport vehicle. For example, the MRO system may determine that the transport vehicle is in good working order, that the transport vehicle is due for scheduled repairs or services, that the transport vehicle has new damage or maintenance concerns, a severity of any damage, issue, concern, or the like. In some case, the status may be coded such as red, yellow, green and/or associated with one or more known maintenance codes.

At 410, the MRO system may determine, based at least in part on the sensor data, the status log, and/or the maintenance log, a first cost associated with preforming MRO. For example, the first cost may represent the cost of performing the MRO currently on the transport. The first cost may represent a monetary cost (such as a cost of materials, labor and the like), a time cost (e.g., the lost production, lost revenue, delays, or the like), and/or a scheduling cost (e.g., delays, rerouting, logistics, and the like) of the transport vehicle.

At 412, the MRO system may determine, based at least in part on the sensor data, the status log, and/or the maintenance log, a second cost associated with deferred MRO. For example, the second cost may represent the cost of deferring or not currently performing the MRO on the transport. The second cost may represent a monetary cost (such as an increase cost of labor due to hampered operations or the like), a risk cost (e.g., potential break downs, potential aggravation to the issues, or the like), and/or an operating cost (e.g., additional labor or the like) associated with the transport vehicle operating in its current status or state.

At 414, the MRO system may determine whether or not to order MRO. For example, the MRO system may determine whether or not to order MRO based on the first cost and the second cost as well as other factors such as delivery expectations, contracts, liabilities, status, availably, and location of other transports in the fleet, current location, availability of repair personal/materials, and the like. If the MRO system does not order the repairs, the process 400 advances to 416. At 416, the MRO system may update the status log and assign additional transport operations to the transport. Otherwise, the process 400 proceeds to 418, and the MRO system updates the status log, the maintenance log, and orders MRO on the transport.

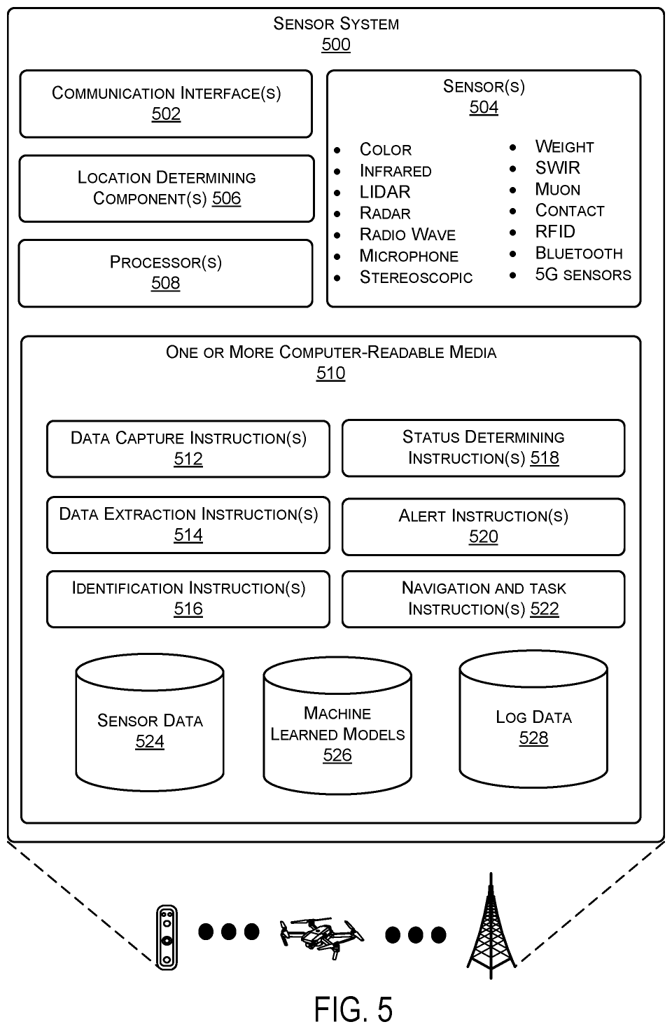

FIG. 5 is an example sensor system 500 that may implement the techniques described herein according to some implementations. For example, the sensor system 500 may be a fixed mounted system, such as an EDGE computing device or incorporated into an AAV, as discussed above.

In some implementations, the sensor system 500 may include one or more communication interface(s) 502 that enables communication between the system 500 and one or more other local or remote computing device(s) or remote services, such as an asset management system of FIGS. 1-3. For instance, the communication interface(s) 502 can facilitate communication with other proximity sensor systems, a central control system, or other facility systems. The communications interfaces(s) 502 may enable Wi-Fi-based communication such as via frequencies defined by the IEEE 802.11 standards, short range wireless frequencies such as Bluetooth, cellular communication (e.g., 2G, 3G, 4G, 4G LTE, 5G, etc.), satellite communication, dedicated short-range communications (DSRC), or any suitable wired or wireless communications protocol that enables the respective computing device to interface with the other computing device(s).

The one or more sensor(s) 504 may be configured to capture the sensor data 524 associated with assets. In at least some examples, the sensor(s) 504 may include thermal sensors, time-of-flight sensors, location sensors, LIDAR sensors, SWIR sensors, radar sensors, sonar sensors, infrared sensors, cameras (e.g., RGB, IR, intensity, depth, etc.), Muon sensors, microphone sensors, environmental sensors (e.g., temperature sensors, humidity sensors, light sensors, pressure sensors, etc.), and the like. In some examples, the sensor(s) 504 may include multiple instances of each type of sensor. For instance, camera sensors may include multiple cameras disposed at various locations.

The sensor system 500 may also include one or more location determining component(s) 506 for determining a global position of the AAV, such as for use in navigation. The location determining component(s) 506 may include one or more sensor package combination(s) including Global Navigation Satellite System (GNSS) sensors and receivers, Global Positioning System (GPS) sensors and receivers, or other satellite systems. For example, the location determining component(s) 506 may be configured to decode satellite signals in various formats or standards, such as GPS, GLONASS, Galileo or BeiDou. In some cases, the location determining component(s) 506 may be placed at various places associated with the assets, THUs, and/or transports to improve the accuracy of the coordinates determined from the data received by each of the location determining component(s) 506.

The sensor system 500 may include one or more processor(s) 508 and one or more computer-readable media 510. Each of the processors 508 may itself comprise one or more processor(s) or processing core(s). The computer-readable media 510 is illustrated as including memory/storage. The computer-readable media 510 may include volatile media (such as random access memory (RAM)) and/or nonvolatile media (such as read only memory (ROM), Flash memory, optical disks, magnetic disks, and so forth). The computer-readable media 510 may include fixed media (e.g., GPU, NPU, RAM, ROM, a fixed hard drive, and so on) as well as removable media (e.g., Flash memory, a removable hard drive, an optical disc, and so forth). The computer-readable media 510 may be configured in a variety of other ways as further described below.

Several modules such as instructions, data stores, and so forth may be stored within the computer-readable media 510 and configured to execute on the processors 508. For example, as illustrated, the computer-readable media 510 stores data capture instructions 512, data extraction instructions 514, identification instructions 516, status determining instructions 518, alert instructions 520, navigation and task instructions 522, as well as other instructions, such as an operating system. The computer-readable media 510 may also be configured to store data, such as sensor data 524 and machine learned models 526, and log data 528 as well as other data.

The data capture instructions 512 may be configured to utilize or activate the sensor systems 504 to capture sensor data 524 associated with a transport vehicle. The captured sensor data 524 may then be stored and/or transmitted or streamed to an MRO system, as discussed herein.

The data extraction instructions 514 may be configured to extract, segment, classify objects represented within the sensor data 524. For example, the data extraction instructions 514 may segment and classify features (such as components) of the transport vehicle as well as other characteristics (such as damage and the like). In some cases, the data extraction instructions 514 may utilize the machine learned models 526 to perform extraction, segmentation, classification, and the like.

The identification instructions 516 may be configured to determine an identity of the transport vehicle. For example, the identification instructions 516 may utilize one or more machine learned model(s) 526 with respect to the sensor data 524 and/or the extracted data to determine the identity of a transport vehicle, as discussed above.

The status determining instructions 518 may be configured to process the sensor data 524 to identify damage, issues, and/or concerns associated with the transport vehicle. For example, the status determining instructions 518 may detect damage using the machine learned models 526 then compare the damage detected with any known damage in the log data 528 to determine if the damage was received during the most recent assignment. In some cases, the status determining instructions 518 may also rate or quantify any damage, for instance, using a severity rating and/or value the damage.

The alert instructions 520 may be configured to alert or otherwise notify maintenance and repair personnel or systems (such as autonomous systems) as to any of the damage, issues and/or concerns detected by the sensor system 500. In some cases, the alert instructions 520 may order operations to be performed. In other cases, the alert instructions 520 may provide reports or updates related to the vehicle.

The navigation instructions 522 may be configured to cause the sensor system to navigate or traverse a flight path or plan in order to capture the sensor data 526 associated with the transport vehicle.

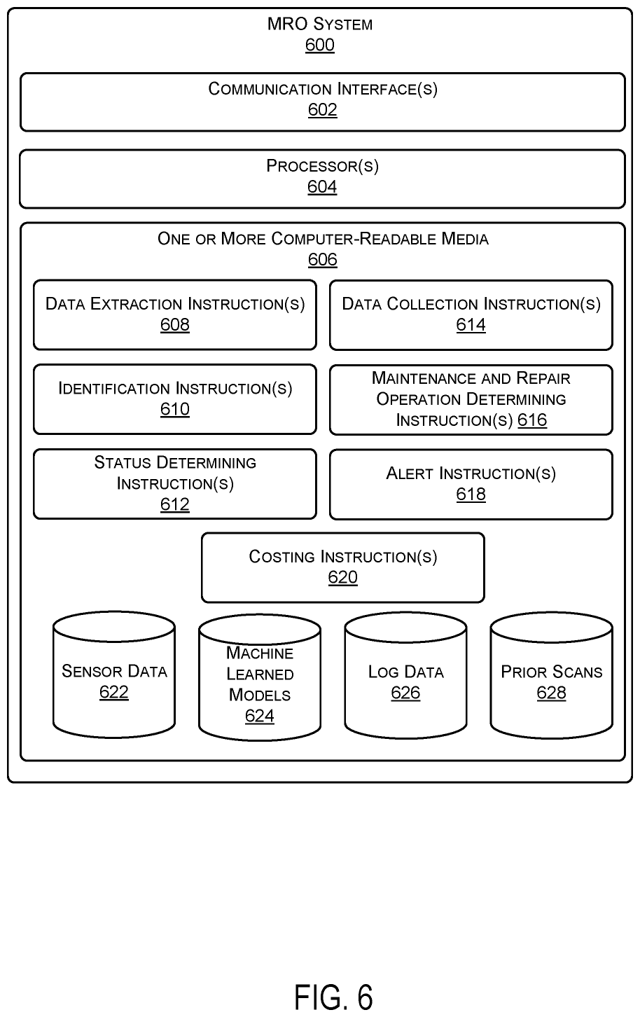

FIG. 6 is an example MRO system 600 that may implement the techniques described herein according to some implementations. The MRO system 600 may include one or more communication interface(s) 602 (also referred to as communication devices and/or modems). The one or more communication interfaces(s) 602 may enable communication between the system 600 and one or more other local or remote computing device(s) or remote services, such as the sensor systems of FIG. 5. For instance, the communication interface(s) 602 can facilitate communication with other proximity sensor systems, a central control system, or other facility systems. The communications interfaces(s) 602 may enable Wi-Fi-based communication such as via frequencies defined by the IEEE 802.11 standards, short range wireless frequencies such as Bluetooth, cellular communication (e.g., 2G, 3G, 4G, 4G LTE, 6G, etc.), satellite communication, dedicated short-range communications (DSRC), or any suitable wired or wireless communications protocol that enables the respective computing device to interface with the other computing device(s).

The MRO system 600 may include one or more processor(s) 604 and one or more computer-readable media 606. Each of the processors 604 may itself comprise one or more processors or processing cores. The computer-readable media 606 is illustrated as including memory/storage. The computer-readable media 606 may include volatile media (such as random access memory (RAM)) and/or nonvolatile media (such as read only memory (ROM), Flash memory, optical disks, magnetic disks, and so forth). The computer-readable media 606 may include fixed media (e.g., GPU, NPU, RAM, ROM, a fixed hard drive, and so on) as well as removable media (e.g., Flash memory, a removable hard drive, an optical disc, and so forth). The computer-readable media 606 may be configured in a variety of other ways as further described below.

Several modules such as instructions, data stores, and so forth may be stored within the computer-readable media 606 and configured to execute on the processors 604. For example, as illustrated, the computer-readable media 606 stores data extraction instructions 608, identification instructions 610, status determining instructions 612, data collection instructions 614, MRO determining instructions 616, alert instructions 618, costing instruction 620, as well as other instructions, such as an operating system. The computer-readable media 606 may also be configured to store data, such as sensor data 622 and machine learned models 624, log data 628, prior scans 630 (such as prior scans of the transport vehicle captured at departure from an origination facility or on a previous visit to the current facility) as well as other data. In some cases, the sensor data 622, log data 626, and/or the prior scans 630 may be time stamped to provide a record, in the form of the logs 626, of the damage to the transport vehicle over time.

The data extraction instructions 608 may be configured to extract, segment, classify objects represented within the sensor data 622. For example, the data extraction instructions 608 may segment and classify features (such as components) of the transport vehicle as well as other characteristics (such as damage and the like). In some cases, the data extraction instructions 608 may utilize the machine learned models 624 to perform extraction, segmentation, classification, and the like.

The identification instructions 610 may be configured to determine an identity of the transport vehicle. For example, the identification instructions 616 may utilize one or more machine learned model(s) 624 with respect to the sensor data 622 and/or the extracted data to determine the identity of a transport vehicle, as discussed above.

The status determining instructions 612 may be configured to process the sensor data 622 to identify damage, issues, and/or concerns associated with the transport vehicle. For example, the status determining instructions 618 may detect damage using the machine learned models 624 then compare the damage detected with any known damage in the log data 626 (such as a prior scan 630) to determine if the damage was received during the most recent assignment. In some cases, the status determining instructions 612 may also rate or quantify any damage, for instance, using a severity rating and/or value the damage.

The data collection instructions 614 may be configured to cause additional sensor data to be collected by the sensor systems, such as sensor systems 500 discussed above with respect to FIG. 5. In some cases, the data collection instructions 614 may include task or instructions for specific vehicles, areas of vehicles, component of vehicles, or the like to be further inspected via the sensor systems. In some examples, the data collection instructions 614 may generate routes or navigation instruction for AAVs or ASVs to capture additional sensor data or provide instructions for manual inspections by facility workers.

The MRO determining instructions 616 may be configured to determine and assign MRO to be performed by autonomous systems or individuals associated with the vehicle (such as maintenance and repair personal) based at least in part on the sensor data 622, the machine learned models 624, the log data 626, the prior scans 628, and any status or other data determined about the vehicle based on the sensor data 622.

The alert instructions 618 may be configured to alert or otherwise notify maintenance and repair personnel or systems (such as autonomous systems) as to any of MRO tasks to be performed with respect to the transport vehicle as well as to relay reports and status to various parties associated with the vehicle and/or the contents being transported by the vehicle.

The costing instruction 620 may be configured to determine a first cost associated with MRO and a second cost associated with deferred MRO based on the log data 626, the sensor data 622 and any output of the machine learned models 624. The first cost may represent a monetary cost (such as a cost of materials, labor and the like), a time cost (e.g., the lost production, lost revenue, delays, or the like), and/or a scheduling cost (e.g., delays, rerouting, logistics, and the like) of the transport vehicle. The second cost may represent a monetary cost (such as an increase cost of labor due to hampered operations or the like), a risk cost (e.g., potential break downs, potential aggravation to the issues, or the like), and/or an operating cost (e.g., additional labor or the like) associated with the transport vehicle operating in its current status or state. Based on the first cost and the second cost the costing instructions may generate a cost associated with MRO and a cost associated with deferred MRO which may either be used to determine if MRO should be performed or deferred for later or provided as part of an alert or report by the alert instructions 618 to an individual to decide if the MRO should be performed or delayed.

### Example Clauses

A. A system comprising: one or more processors; and one or more non-transitory computer-readable media storing instructions that, when executed by the one or more processors, cause the one or more processors to perform operations comprising: receiving first sensor data associated with a transport vehicle; determining, based at least in part on the first sensor data, a status of the transport vehicle; and updating, based at least in part on the status, a log associated with the transport vehicle.

B. The system of claim A, the operations further comprising: in response to detecting a transport is entering the facility prior, causing an autonomous system to generate the first sensor data.

C. The system of claims A or B, wherein determining the status of the transport vehicle further comprises: determining an identity of the transport vehicle based at least in part on the sensor data; and determining the status is based at least in part on the identity.

D. The system of claims A-C, wherein determining the status of the transport vehicle further comprises: identifying the log based at least in part on the identity; and determining the status is based at least in part on the log.

E. The system of claim D, wherein the log is at least one of a status log or maintenance log.

F. The system of claims A-E, the operations further comprising: sending an alert to at least one system based at least in part on the status.

G. The system of claims A-F, the operations further comprising: in response to determining the identity, determining a known issue associated with the transport vehicle; causing the autonomous system to generate the second sensor data, the second sensor data associated with a location of the known issue; and wherein determining the status of the transport vehicle is based at least in part on the second sensor data.

H. The system of claims A-G, the operations further comprising: ordering a maintenance and repair operation based at least in part on the status.

I. The system of claims A-H, the operations further comprising: receiving third sensor data associated with the transport, the second sensor data received after a completion of the maintenance and repair operation; determining a second status of the transport vehicle is based at least in part on the third sensor data.

J. The system of claim A-I, the operations further comprising: determining a first cost associated with the maintenance and repair operation based at least in part on the first sensor data or the second sensor data; and determining a second cost associated with deferring the maintenance and repair operation based at least in part on the first sensor data or the second sensor data.

K. The system of claim A-J, wherein ordering the maintenance and repair operation is based at least in part on the first cost or the second cost.

While the example clauses described above are described with respect to one particular implementation, it should be understood that, in the context of this document, the content of the example clauses can also be implemented via a method, device, system, a computer-readable medium, and/or another implementation. Additionally, any of examples may be implemented alone or in combination with any other one or more of the other examples.

1. A method comprising:
receiving first sensor data associated with a transport vehicle;
determining, based at least in part on the first sensor data, a status of the transport vehicle; and
updating, based at least in part on the status, a log associated with the transport vehicle.

2-15. (canceled)

16. The method of claim 1, further comprising in response to detecting the transport vehicle is entering a facility prior, causing an autonomous system to generate the first sensor data.

17. The method of claim 1, wherein determining the status of the transport vehicle further comprises:
determining an identity of the transport vehicle based at least in part on the sensor data; and
determining the status is based at least in part on the identity.

18. The method of the claim 17, wherein determining the status of the transport vehicle further comprises:
identifying the log based at least in part on the identity; and
determining the status is based at least in part on the log.

19. The method of the claim 18, wherein the log is at least one of a status log or maintenance log.

20. The method of the claim 18, further comprising sending an alert to at least one system based at least in part on the status.

21. The method of the claim 18, further comprising:
in response to determining the identity, determining a known issue associated with the transport vehicle;
receiving second sensor data, the second sensor data associated with a location of the known issue; and
wherein determining the status of the transport vehicle is based at least in part on the second sensor data.

22. The method of the claim 21, further comprising ordering a maintenance and repair operation based at least in part on the status.

23. The method of the claim 22, further comprising:
receiving third sensor data associated with the transport, the second sensor data received after a completion of the maintenance and repair operation; and
determining a second status of the transport vehicle is based at least in part on the third sensor data.

24. The method of the claim 22, further comprising:
determining a first cost associated with the maintenance and repair operation based at least in part on the first sensor data or the second sensor data; and
determining a second cost associated with deferring the maintenance and repair operation based at least in part on the first sensor data or the second sensor data.

25. The method of the claim 22, wherein ordering the maintenance and repair operation is based at least in part on the first cost or the second cost.

26. A system comprising:
one or more processors; and
one or more non-transitory computer readable media storing instructions executable by the one or more processors, wherein the instructions, when executed, cause the system to perform operations comprising:
responsive to detecting a transport vehicle is entering a facility, causing an autonomous system to generate first sensor data associated with the transport vehicle;
determining, based at least in part on the first sensor data, an identity of the transport vehicle; and
determining a status of the transport vehicle based at least in part on the identity, the first sensor data, and stored log data associated with the transport vehicle;
determining a maintenance operation associated with the transport vehicle based at least in part on the first sensor data;
updating, based at least in part on the status, the log data associated with the transport vehicle;
sending a report to a third-party system, the report including the maintenance operations and an estimated repair or maintenance cost;
receiving an approval for the maintenance operation from the third-party system; and
sending instruction to initiate the maintenance operation.

27. The system of claim 26, wherein the report includes a damage report, a suggested repair operation, a rating associated with the readiness of the transport vehicle.

28. The system of claim 26, wherein the operations further comprise sending an alert to at least one third-party system based at least in part on the status and the repair operation, the alert including a suggested repair operation.

29. The system of claim 26, wherein the operations further comprise ordering a maintenance and repair operation based at least in part on the status.

30. One or more non-transitory computer readable media storing instructions executable by one or more processors, wherein the instructions, when executed, cause the processors to perform operations comprising:
responsive to detecting a transport vehicle is entering a facility, causing an autonomous system to generate first sensor data associated with the transport vehicle;
determining, based at least in part on the first sensor data, an identity of the transport vehicle; and
determining a status of the transport vehicle based at least in part on the identity, the first sensor data, and stored log data associated with the transport vehicle;
determining a maintenance operation associated with the transport vehicle based at least in part on the first sensor data;
updating, based at least in part on the status, the log data associated with the transport vehicle;
sending a report to a third-party system, the report including the maintenance operations and an estimated repair or maintenance cost;
receiving an approval for the maintenance operation from the third-party system; and
sending instruction to initiate the maintenance operation.

31. The one or more non-transitory computer readable media of claim 30, wherein the report includes a damage report, a suggested repair operation, a rating associated with the readiness of the transport vehicle.

32. The one or more non-transitory computer readable media of claim 30, wherein the operations further comprise sending an alert to at least one third-party system based at least in part on the status and the repair operation, the alert including a suggested repair operation.

33. The one or more non-transitory computer readable media of claim 30, wherein the operations further comprise ordering a maintenance and repair operation based at least in part on the status.

34. The one or more non-transitory computer readable media of claim 30, wherein the operations further:
determining a first cost associated with the maintenance and repair operation based at least in part on the first sensor data; and
determining a second cost associated with deferring the maintenance and repair operation based at least in part on the first sensor data.
